(19) United States
(12) Patent Application Publication
(10) Pub. No.: US 2013/0045723 A1
(43) Pub. Date: Feb. 21, 2013

(54) CALL ATTEMPT NOTIFICATION

(71) Applicants: Thomas Sony, Padi (IN); Janardhan Harish, Chennai (IN)

(72) Inventors: Thomas Sony, Padi (IN); Janardhan Harish, Chennai (IN)

(73) Assignee: ALCATEL LUCENT, Paris (FR)

(21) Appl. No.: 13/580,487

(22) PCT Filed: Feb. 22, 2010
(86) PCT No.: PCT/IB2010/000623

§ 371 Date: Nov. 8, 2012

(51) Int. Cl. H04W 4/16

(52) U.S. Cl. 455/414.1

(57) ABSTRACT

The embodiments herein relate to call lists that detail all call attempts made to a called party that have not been successful in communication networks. The reasons for the failure can range from no answer to out of range or congestion in the network. A system and method is disclosed for notifying a called user of a failed call attempt made by a calling user. A switch receives a call request from a calling user and on determining that a communication session cannot be established between the calling user and the called user, the switch terminates the link to the calling user and sends the call attempt notification to the called user. The called user would be notified of the call attempt made by the calling user, the contact details of the calling user and reason for the failure of the call attempt.

### TECHNICAL FIELD

The present invention relates to communication networks and, more particularly, to failed call attempts in communication networks.

### BACKGROUND

Outgoing Call Barring (OCB) is a feature wherein all the calls or some of the calls from a particular calling user are blocked. The OCB feature may be implemented if the calling user has not paid any outstanding bills or f the called user does not want to receive any calls from the calling user. The switch in a communication network checks the profile of the called user and determines if a call from the calling user can be allowed to reach the called user or has to be barred. If the switch determines that the call has to be barred, then the communication link with the calling user would be broken and the called user would not be aware of the call attempt made by the calling user. The called user would thus not be able to give a call back to the calling user.

In some situations it may also happen that the call attempt from the calling user may fail due to some network related condition. For example, there may be a disturbance on the communication link from the switch to the called user. Also, network congestion may happen due to error caused because of insufficient Switch resources like Memory overload, Processor overload, bandwidth or circuit limitations, etc. Here, the needed communication session would not be established between the calling user and the called user. Also, the called user would be unaware of the call attempt made by the calling user and if the call is important, then the called user would not have the option of giving a call back to the calling user. For example, if the calling user is facing a medical emergency and the call attempt made by the called user is barred, then the called user would be unaware of the call attempt made by the calling user. The called user would thus not have the option of making a call back to the calling user and the calling user may not get the required medical attention in time.

### SUMMARY

In view of the foregoing, an embodiment herein provides a method for notifying a called user of a failed call attempt, wherein the call attempt is made by a calling user to the called user, in a communication network. A switch receives a call request from a calling user and the switch notifies the called user of the call attempt when a communication session cannot be established between the calling user and the called user. The switch checks the profile of the calling user and determines if a communication session can be established between the calling user and the called user. The notification is sent as at least one of Short Message Service (SMS) or Multimedia Messaging Service (MMS) for Mobile Network, MESSAGE Method for SIP, a ringing tone for a pre-determined duration of time followed by Calling Line Identification Presentation (CLIP) for PSTN-Analog, FACILITY message (DSS1) for PSTN-ISDN. The notification includes contact details of the calling user, wherein the contact details includes at least one of contact number of calling user, time of the call attempt and reason for failure of the call attempt. The calling user and the called user may be in same communication network or the calling user and the called user may be in different communication networks. The communication network is either of Session Initiation Protocol (SIP) network, Public Land Mobile Network (PLM) or Public Switched Telephone Network (PSTN).

Embodiments further disclose a switch for notifying a called user of a failed call attempt, wherein the call attempt is made by a calling user to the called user, in a communication network. The switch receives a call request from the calling user and notifies the called user of the call attempt when a communication session cannot be established between the calling user and the called user. The switch checks the profile of the calling user and determines if a communication session can be established between the calling user and the called user. The switch obtains the profile of the calling user from at least one of an internally located memory and an externally located memory. The switch sends the notification using at least one of Short Message Service (SMS) or Multimedia Messaging Service (MMS) for Mobile Network, MESSAGE Method for SIP, a ringing tone for a pre-determined duration of time followed by Calling Line Identification Presentation (CLIP) for PSTN-Analog, FACILITY message (DSS1) for PSTN-ISDN. The switch notifies the called user, when the calling user and the called user are in a same communication network or when the calling user and the called user are in different communication networks. The switch sends the details of the calling user in the notification sent to the called user. These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 illustrates a block diagram of a switch connected to users in a communication network, according to an embodiment herein;

FIG. 2 illustrates an example implementation in a SIP network, according to an embodiment herein;

FIG. 3 illustrates an example implementation in a PLMN network, according to an embodiment herein;

FIG. 4 illustrates a block diagram of a switch, according to an embodiment herein;

FIG. 5 is a flowchart depicting a method for notifying the called user of a failed call attempt, according to an embodiment herein;

FIG. 6 illustrates a flow diagram for notifying the called user of a failed call attempt, when the calling and the called user's are in the same SIP network, according to an embodiment herein;

FIG. 7 illustrates a flow diagram for notifying the called user of a failed call attempt, when the calling user and the called user are in different SIP networks, according to an embodiment herein; and

FIG. 8 illustrates a flow diagram for notifying the called user of a failed call attempt, when the calling and the called user's are in different PLMN networks, according to an embodiment herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

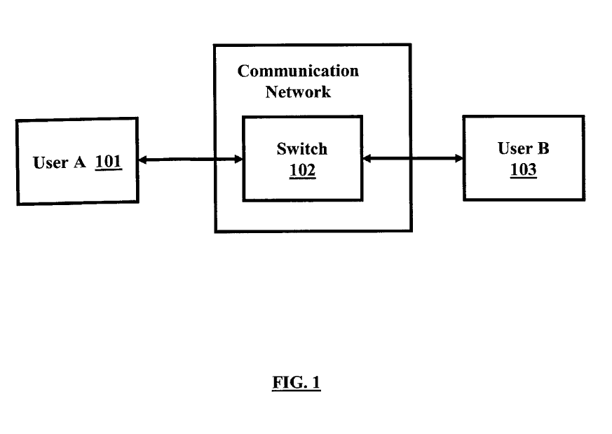

The embodiments herein disclose a system and method for notifying a called user of a failed call attempt made by a calling user. Referring now to the drawings, and more particularly to FIGS. 1 through 8, where similar reference characters denote corresponding features consistently throughout the figures, there are shown embodiments.

FIG. 1 illustrates a block diagram of a switch connected to users in a communication network. If user A 101 wants to start a communication session with user B 103, then user A 101 sends a call request to user B 103 through a switch 102. The switch 102 in the communication network establishes and maintains communication sessions between users in the network. The switch 102 routes a call from user A 101 to user B 103. On receiving the call request, the switch 102 checks the profile of user A 101 and determines if user A 101 is allowed to make the call. For example, the profile may have details of the identity of user A 101, address, details about any call barring to be applied to user A 101, charging scheme, and any other details of user A 101. After checking the profile of user A 101, the switch 102 can determine if calls from user A 101 have been barred. If calls from user A 101 are not barred, then the switch 102 establishes a communication session between user A 101 and user B 103. If calls from user A 101 are barred, then the switch 102 does not establish a communication session between user A 101 and user B 103. The switch 102 may also not be able to establish a communication session between user A 101 and user B 103 due to network related conditions. For example, the communication between the switch 102 and user B 103 may not be functioning because of insufficient free resources, such as channel, bandwidth, Memory or CPU load, in switch 102. If a communication session is not established between user A 101 and user B 103, the call attempt made by user A 101 fails, and the switch 102 sends a notification to user B 103 to indicate the call attempt made by user A 101. The notification may include the contact details of user A 101. For example, the notification may be sent as a Message Method and the Message Method may include the contact number of user A 101, the time of the call attempt and the reason for the failure of the call attempt. On receiving the call attempt notification, user B 103 may choose to call back user A 101.

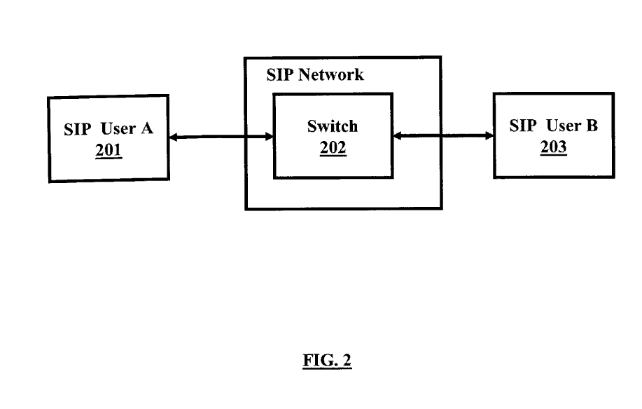

FIG. 2 illustrates an example implementation in a SIP network. If SIP (Session Initiation Protocol) user A 201 wants to start a communication session with SIP user B 203, then SIP user A 201 sends a call request to SIP user B 203 through a switch 202. The switch 202 in the SIP network establishes and maintains communication sessions between users in the network. The switch 202 routes a call from SIP user A 201 to SIP user B 203. On receiving the call request, the switch 202 checks the profile of SIP user A 201 and determines if SIP user A 201 is allowed to make the call. For example, the profile may have details of the identity of SIP user A 201, address, details about any call barring to be applied to SIP user A 201, charging scheme, and any other details of SIP user A 201. After checking the profile of SIP user A 201, the switch 202 can determine if calls from SIP user A 201 have been barred. If calls from SIP user A 201 are not barred, then the switch 202 establishes a communication session between SIP user A 201 and SIP user B 203. If calls from SIP user A 201 are barred, then the switch 202 does not establish a communication session between SIP user A 201 and SIP user B 203. The switch 202 may also not be able to establish a communication session between SIP user A 201 and SIP user B 203 due to network related conditions. For example, the communication network between the switch 202 and SIP user B 203 may not be functioning. If a communication session is not established between SIP user A 201 and SIP user B 203, the call attempt made by SIP user A 201 fails, and the switch 202 sends a notification to SIP user B 203 to indicate the call attempt made by SIP user A 201. The notification may include the contact details of SIP user A 201. For example, the notification may be sent as a Message Method and the Message Method may include the contact number of SIP user A 201, the time of the call attempt and the reason for the failure of the call attempt. The data content may be sent in text format or in Extensible Markup Language (XML) format. On receiving the call attempt notification, SIP user B 203 may choose to call back SIP user A 201.

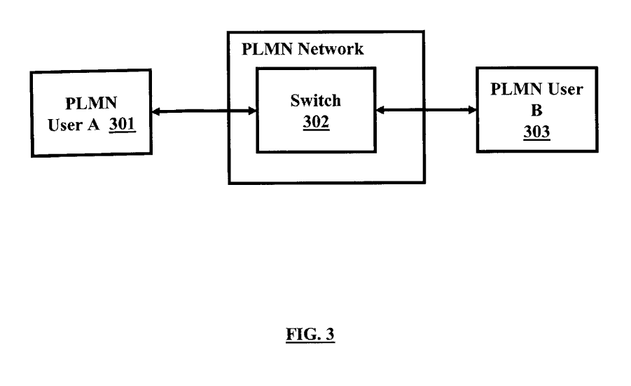

FIG. 3 illustrates an example implementation in a PLMN network. If PLMN (Public Land Mobile Network) user A 301 wants to start a communication session with PLMN user B 303, then PLMN user A 301 sends a call request to PLMN user B 303 through a switch 302. The switch 302 in the PLMN network establishes and maintains communication sessions between users in the network. The switch 302 routes a call from PLMN user A 301 to PLMN user B 303. On receiving the call request, the switch 302 checks the profile of PLMN user A 301 and determines if PLMN user A 301 is allowed to make the call. For example, the profile may have details of the identity of PLMN user A 301, address, details about any call barring to be applied to PLMN user A 301, charging scheme, and any other details of PLMN user A 301. After checking the profile of PLMN user A 301, the switch 302 can determine if calls from PLMN user A 301 have been barred. If calls from PLMN user A 301 are not barred, then the switch 302 establishes a communication session between PLMN user A 301 and PLMN user B 303. If calls from PLMN user A 301 are barred, then the switch 302 does not establish a communication session between PLMN user A 301 and PLMN user B 303. The switch 302 may also not be able to establish a communication session between PLMN user A 301 and PLMN user B 303 due to network related conditions. If a communication session is not established between PLMN user A 301 and PLMN user B 303, the call attempt made by PLMN user A 301 fails, and the switch 302 sends a notification to PLMN user B 303 to indicate the call attempt made by PLMN user A 301. The notification may include the contact details of PLMN user A 301. For example, the notification may be sent as Short Message Service (SMS) and the SMS may include the contact number of PLMN user A 301, the time of the call attempt and the reason for the failure of the call attempt. In a second example, the notification may be sent as a Multimedia Messaging Service (MMS). On receiving the call attempt notification, PLMN user B 303 may choose to call back PLMN user A 301.

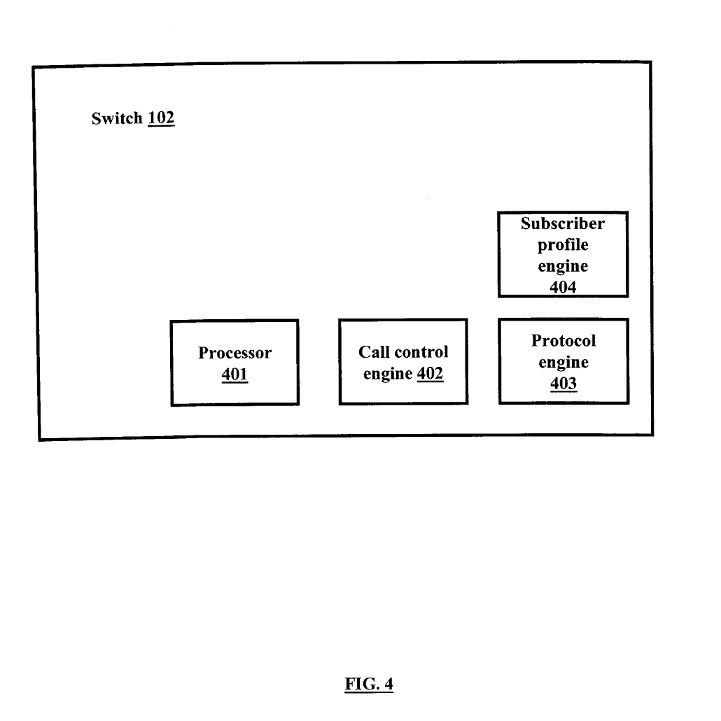

FIG. 4 illustrates a block diagram of a switch. If the calling user wants to start a communication session with the called user, then the calling user sends a call request to the called user through a switch 102. The switch 102 establishes and maintains communication sessions between users in the network. The switch 102 routes a call from the calling user to the called user. A protocol engine 403 in the switch 102 receives the call request and determines that the calling user wants to start a communication session with the called user. The protocol engine 403 then informs a call control engine 402 of the call request from the calling user. On being notified of the call request from the calling user, the call control engine 402 obtains details of the calling user from a subscriber profile engine 404. The subscriber profile engine 404 has the profile details of the calling user. For example, the subscriber profile engine 404 may have details of the identity of the calling user, address, details about any call barring to be applied to the calling user, charging scheme, privileges given to the calling user, subscription information and any other detail of the calling user. In other embodiments the details of the calling user may be present in a memory located outside the switch 102. For example, the details of the calling user may be stored in a Home Location Register (HLR). If the details of the calling user are present in a memory located outside the switch 102, then the switch 102 obtains the details from the externally located memory. After obtaining the details of the calling user, the call control engine 402 determines if a communication session can be established between the calling user and the called user. If the details of the calling user indicate that the communication session can be established between the calling user and the called user, then the call control engine 402 instructs the protocol engine 403 to establish the communication session. If the details of the calling user indicate that calls from the calling user are barred, then the call control engine 402 instructs the protocol engine 403 to terminate the communication link with the calling user. The protocol engine 403 may also indicate to the calling user that the call is barred. The call request from the calling user may also fail due to some network related conditions or calling user may not have enough credit make a call. The call control engine 402 also instructs the protocol engine 403 to send a notification to the called user indicating of the failed call attempt. The notification sent by the protocol engine 403 may include the contact details of calling user and the time of the call attempt. For example, if the calling user and the called user are in a SIP network then the protocol engine 403 may send the notification as a Message Method and if the users are in a PLMN network, then the protocol engine 403 may send the notification as an SMS. The protocol engine 403 includes all the required information in the notification before sending the notification to the called user. A processor 401 controls the functioning of the switch 102.

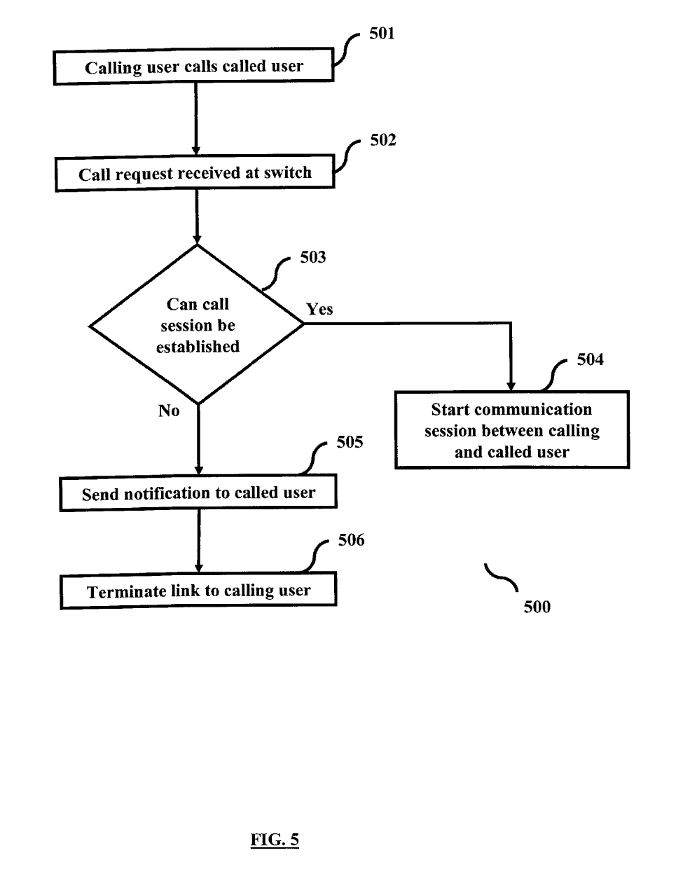

FIG. 5 is a flowchart depicting a method for notifying the called user of a failed call attempt. If the calling user wants to start a communication session with the called user, then the calling user sends (501) a call request to the called user. The switch 102 receives (502) the call request and determines that the calling user wants to start a communication session with the called user. The switch 102 checks (503) the profile of the calling user and determines if a communication session can be established between the calling user and the called user. If a communication session can be established between the calling user and the called user, then the switch 102 establishes (504) a communication session between the users. If a communication session cannot be established between the calling user and the called user, the switch 102 terminates (506) the link with the calling user and also sends a notification (505) to the called user informing the called user of the failed call attempt. The switch 102 may terminate the link with the calling user, if the calling user is not allowed to make the call or the switch 102 is unable to establish a communication link with the called user due to some network condition. On receiving the call attempt notification the called user may choose to call calling user. The various actions in method 500 may be performed in the order presented, in a different order or simultaneously. Further, in some embodiments, some actions listed in FIG. 5 may be omitted.

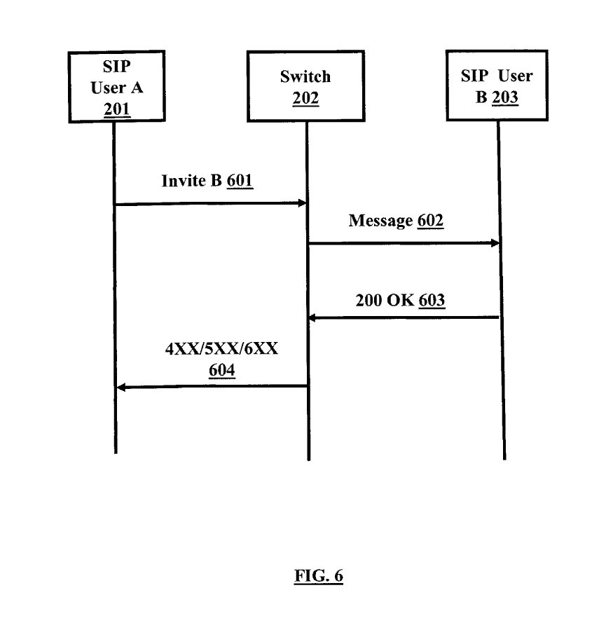

FIG. 6 illustrates a flow diagram for notifying the called user of a failed call attempt, when the calling user and the called user are in the same SIP network. If SIP user A 201 wants to start a communication session with SIP user B 203, then SIP user A 201 sends a call request to SIP user B 203 through the switch 202. For example, the call request may be sent as an Invite B 601 message. On receiving the call request, the switch 202 checks the profile of SIP user A 201 and determines if SIP user A 201 is allowed to make the call. After checking the profile of SIP user A 201, the switch 202 can determine if calls from SIP user A 201 have been barred. If calls from SIP user A 201 are barred, then the switch 202 does not establish a communication session between SIP user A 201 and SIP user B 203. The switch 202 may also not be able to establish a communication session between SIP user A 201 and SIP user B 203 due to network related conditions. For example, the switch 202 may not be able to route the call request to SIP user B 203. If a communication session is not established between SIP user A 201 and SIP user B 203, the call attempt made by SIP user A 201 fails, and the switch 202 sends a notification to SIP user B 203 to indicate the call attempt made by SIP user A 201. The notification may include the contact details of SIP user A 201. For example, the notification may be sent as a SIP MESSAGE 602. On receiving the notification from the switch 202, the communication terminal of SIP user B 203 sends an acknowledgement to the switch 202 indicating the reception of the notification. For example, the acknowledgement may be sent as a 200 OK 603 message. On receiving the acknowledgement, the switch 202 sends a message to SIP user A 201 indicating the failure of the call attempt. For example, the message sent by switch 202 to SIP user A 201 may be the SIP error response code 4XX/5XX/6XX 604. The switch 202 also terminates the link with SIP user A 201.

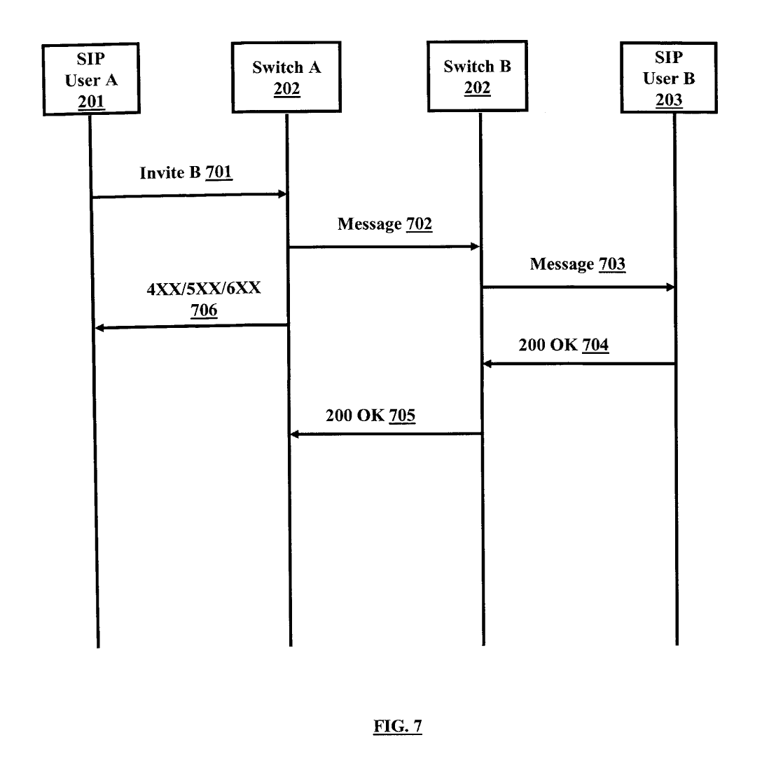

FIG. 7 illustrates a flow diagram for notifying the called user of a failed call attempt, when the calling user and the called user are in different SIP networks. If SIP user A 201 wants to start a communication session with SIP user B 203, then SIP user A 201 sends a call request to SIP user B 203 through the switch A 202. For example, the call request may be sent as an Invite B 701 message. On receiving the call request, the switch A 202 checks the profile of SIP user A 201 and determines if SIP user A 201 is allowed to make the call. After checking the profile of SIP user A 201, the switch A 202 can determine if calls from SIP user A 201 have been barred. If calls from SIP user A 201 are barred, then the switch A 202 does not establish a communication session between SIP user A 201 and SIP user B 203. The switch A 202 may also not be able to establish a communication session between SIP user A 201 and SIP user B 203 due to network related conditions. If a communication session is not established between SIP user A 201 and SIP user B 203, the call attempt made by SIP user A 201 fails, and the switch A 202 sends a notification to SIP user B 203, through switch B 202, to indicate the call attempt made by SIP user A 201. The notification may include the contact details of SIP user A 201. For example, the notification may be sent as a SIP MESSAGE 702. On receiving the notification, switch B 202 routes the message to SIP user B 203. For example, the notification sent by switch B 202 may be sent as a SIP MESSAGE 703.

On receiving the notification, the communication terminal of SIP user B 203 sends an acknowledgement to the switch A 202, through switch B 202, indicating the reception of the notification. For example, the acknowledgement sent by SIP user B 203 to switch B 202 may be sent as a 200 OK 704 message and the acknowledgement sent by switch B 202 to switch A 202 may be sent as a 200 OK 705 message. On receiving the acknowledgement, the switch A 202 sends a message to SIP user A 201 indicating the failure of the call attempt. For example, the message sent by switch A 202 to SIP user A 201 may be the SIP error code 4XX/5XX/6XX 706. The switch A 202 also terminates the link with SIP user A 201.

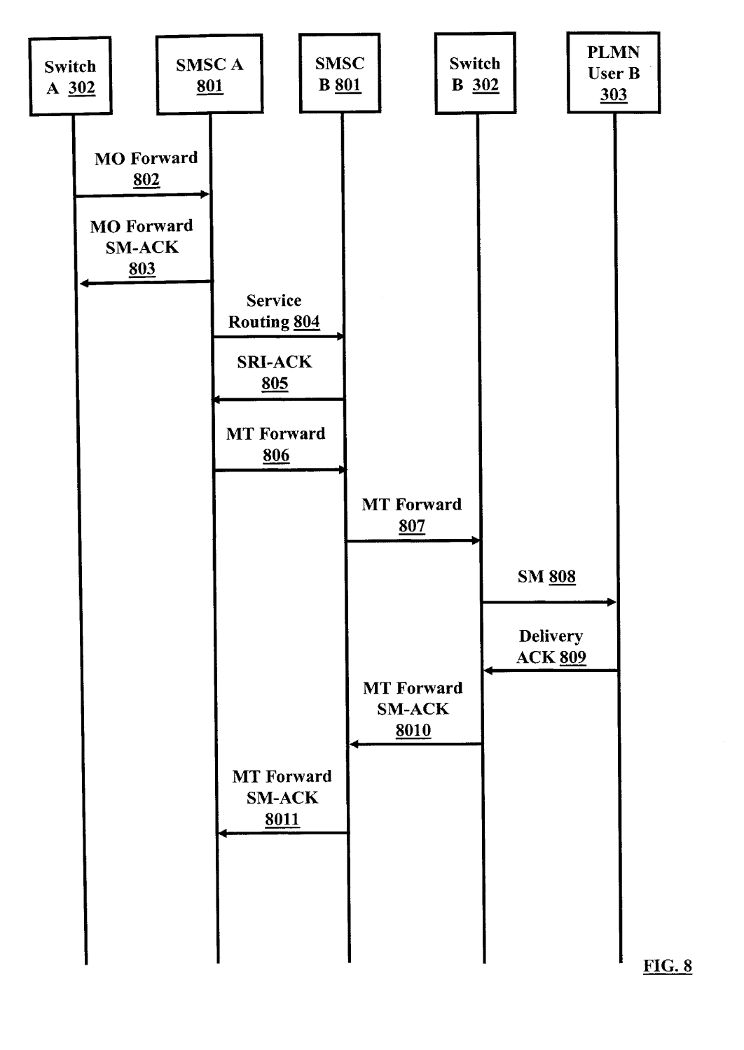

FIG. 8 illustrates a flow diagram for notifying the called user of a failed call attempt, when the calling and the called user's are in different PLMN networks. If PLMN user A 301 wants to start a communication session with PLMN user B 303, then PLMN user A 301 sends a call request to PLMN user B 303 through the switch A 302. On receiving the call request, the switch A 302 checks the profile of PLMN user A 301 and determines if PLMN user A 301 is allowed to make the call. After checking the profile of PLMN user A 301, the switch A 302 can determine if calls from PLMN user A 301 have been barred. If calls from PLMN user A 301 are barred, then the switch A 302 does not establish a communication session between PLMN user A 301 and PLMN user B 303. The switch A 302 may also not be able to establish a communication session between PLMN user A 301 and PLMN user B 303 due to network related conditions. If a communication session is not established between PLMN user A 301 and PLMN user B 303, the call attempt made by PLMN user A 301 fails, and the switch A 302 sends a notification to PLMN user B 303, through Short Message Service Center (SMSC) A 801, SMSC B 801 and switch B 302, to indicate the call attempt made by PLMN user A 301. The notification may include the contact details of PLMN user A 301. For example, the notification may be sent as a Short Message (SM) and the message sent to SMSC A 801 may be a Mobile Originating (MO) Forward 802 message. The SMSC A 801 routes the message sent from the switch 302 to the destination. If a communication link cannot be established, then the SMSC A 801 stores the message and forwards the message to the destination when a communication link can be established with the destination.

On receiving the message, SMSC A 801 sends an acknowledgement to the switch 302 indicating the reception of the message. For example, the acknowledgement sent by SMSC A 801 to switch A 302 may be an MO Forward SM-ACK 803 message. SMSC A 801 then sends a query to SMSC B 801, in the network of PLMN user B 303, requesting for information to route the message to PLMN user B 303. For example, the query sent may be the Service Routing 804 message. The SMSC B 801 responds to the query by sending the required routing information to the SMSC A 801. For example, the information may be sent as a Service Routing Information (SRI)-ACK 805 message. On receiving the routing information, SMSC A 801 uses the received routing information and sends the SM to SMSC B 801. For example, the SM may be sent to SMSC B 801 using a Mobile Terminating (MT) Forward 806 message. SMSC B 801 then sends the SM to PLMN user B 303 through the switch B 302. For example, the message sent to switch 302 may be a MT Forward 807 message and the message sent to PLMN user B 303 from switch B 302 may be a SM 808 signal. The communication terminal of PLMN user B 303 sends an acknowledgement to switch B 302 acknowledging the successful receipt of the message. For example, the acknowledgement sent from the communication terminal of PLMN user B 303 to switch B 302 may be as a Delivery ACK 809 message. Switch B 302 then forwards the acknowledgement to SMSC A 801 through SMSC B 801. For example, the acknowledgement sent by switch B 302 to SMSC B 801 may be a MT Forward SM-ACK 8010 message and the acknowledgement sent by SMSC B 801 to SMSC A 801 may be a MT Forward SM-ACK 8011 message.

In other embodiments, the calling user and the called user may be in the same Public Switched Telephone Network (PSTN) or the calling user and the called user may be in different PSTN's. In such embodiments, if the called user is an Analog PSTN user, the notification may be made by sending the CLIP-A (Calling Line Presentation—Analog) through FSK (Frequency Shift Keying) transmission along with ringing current for a pre-determined duration, to the communication terminal of the called user. If the called user is an ISDN PSTN user, the notification may be made by sending DSS1 FACILITY message to the communication terminal of the called user. In the case when the calling user and the called user are in different Public Switched Telephone Network (PSTN) network the notification may be done through the Common Channel Signaling 7 (CCS7) protocol (SCCP-TCAP message).

The embodiments disclosed herein can be implemented through at least one software program running on at least one hardware device and performing network management functions to control the network elements. The network elements shown in FIG. 1, FIG. 2, FIG. 3 and FIG. 4 include blocks which can be at least one of a hardware device, or a combination of hardware device and software module.

The embodiment disclosed herein specifies a system and method for notifying the called user of a failed call attempt made by the calling user. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a code written in e.g. Very high speed integrated circuit Hardware Description Language (VHDL) or any other coding language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. The method embodiments described herein could be implemented in pure hardware or partly in hardware and partly in software. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for notifying a called user of a failed call attempt, wherein said call attempt is made by a calling user to said called user, in a communication network, said method comprising steps of
a switch (102) receiving a call request from a calling user; and
said switch (102) notifying said called user of said call attempt when a communication session cannot be established between said calling user and said called user.

2. The method, as claimed in claim 1, wherein said switch (102) checks profile of said calling user and determines if a communication session can be established between said calling user and said called user.

3. The method, as claimed in claim 1, wherein said notification is sent as at least one of
Short Message Service (SMS);
Multimedia Messaging Service (MMS);
Session Initiation Protocol (SIP) MESSAGE Method Digital Subscriber Signaling System No. 1 (DSS1) FACILITY method
a ringing tone for a pre-determined duration of time followed by
Calling Line Identification Presentation (CLIP).

4. The method, as claimed in claim 1, wherein said notification includes contact details of said calling user, wherein said contact details comprises at least one of:
contact number of calling user;
time of said call attempt; and
reason for failure of said call attempt.

5. The method, as claimed in claim 1, wherein said calling user and said called user are in same communication network.

6. The method, as claimed in claim 1, wherein said calling user and said called user are in different communication networks.

7. The method, as claimed in claim 1, wherein said communication network is either of:
Session Initiation Protocol (SIP) network;
Public Land Mobile Network (PLMN); or
Public Switched Telephone Network (PSTN).

8. A switch (102) for notifying a called user of a failed call attempt, wherein said call attempt is made by a calling user to said called user, in a communication network, said switch (102) comprising at least one means adapted for
receiving a call request from said calling user; and
notifying said called user of said call attempt when a communication session cannot be established between said calling user and said called user.

9. The switch (102), as claimed in claim 8, wherein said switch (102) is adapted to check profile of said calling user and determine if a communication session can be established between said calling user and said called user.

10. The switch (102), as claimed in claim 9, wherein said switch (102) is adapted to obtain profile of said calling user from at least one of:
an internally located memory (304); and
an externally located memory.

11. The switch (102), as claimed in claim 8, wherein said switch (102) is adapted to send said notification using at least one of:
Short Message Service (SMS);
Multimedia Messaging Service (MMS);
Session Initiation Protocol (SIP) MESSAGE Method (SIP);
Digital Subscriber Signaling System No. 1 (DSS1) FACILITY method
a ringing tone for a pre-determined duration of time followed by
Calling Line Identification Presentation (CLIP).

12. The switch (102), as claimed in claim 8, wherein said switch (102) is adapted to send details of said calling user in said notification sent to said called user.

13. The switch (102), as claimed in claim 8, wherein said switch (102) is adapted to notify said called user, when said calling user and said called user are in a same communication network.

14. The switch (102), as claimed in claim 8, wherein said switch (102) is adapted to notify said called user, when said calling user and said called user are in different communication networks.
